(19) United States
(12) Patent Application Publication
(10) Pub. No.: US 2011/0060898 A1
(43) Pub. Date: Mar. 10, 2011

(54) COMPUTER MOTHERBOARD WITH BASIC INPUT OUTPUT SYSTEM CAPABLE OF BUILT-IN BIOS FRESH

(76) Inventors: Pai-Lin Huang, Jung-Ho (TW); Ming-Feng Fan, Kunshan (CN); Meng-Lin Wu, Jung-Ho (TW)

(21) Appl. No.: 12/555,444

(22) Filed: Sep. 8, 2009

(51) Int. Cl. G06F 9/24; G06F 9/44

(52) U.S. Cl. 713/2; 717/168

(57) ABSTRACT

A computer motherboard with a Basic Input Output System (BIOS) is characterized by built-in BIOS fresh. The BIOS includes a first means and a second means. The first and second means are code internally provided in the BIOS and executable by a CPU of the computer motherboard in an execution environment preset by the BIOS. The first means selects a BIOS update file stored in a storage device. The second means enables the BIOS update file to be refreshed in a BIOS memory. After the computer motherboard enters a BIOS setup utility, a user selects an option of execution of the first or second means to let BIOS fresh takes place without using an operating system.

### FIELD OF THE INVENTION

The present invention relates to computer motherboards, and more particularly, to a computer motherboard with a Basic Input Output System (BIOS) capable of built-in BIOS fresh.

### BACKGROUND OF THE INVENTION

Manufacturers usually provide an upgrade kit for the Basic Input Output System (BIOS) of a conventional computer motherboard. The upgrade kit comprises a BIOS file and a BIOS fresh utility for upgrading the BIOS. After obtaining (for example, downloading from a Website on the Internet) the upgrade kit, an end user executes the BIOS fresh utility included in the upgrade kit under an operating system, such as DOS, Windows, or Linux, installed on the conventional computer motherboard so as to update the BIOS. The conventional computer motherboard can fresh the BIOS on condition that: 1. a ready-to-operate operating system has been installed on the conventional computer motherboard; and 2. the manufacturer of the conventional computer motherboard provides a BIOS fresh utility compatible with the operating system currently installed on the conventional computer motherboard. However, if the BIOS fresh utility provided by the manufacturer of the conventional computer motherboard is not compatible with the operating system currently installed on the conventional computer motherboard, the current operating system will have to be uninstalled so as for another operating system compatible with the BIOS fresh utility to be installed on the conventional computer motherboard.

The inventor of the present invention realized the aforesaid drawbacks of the conventional computer motherboard in freshing the BIOS thereof and endeavored to overcome the aforesaid drawbacks by inventing a computer motherboard with a BIOS capable of built-in BIOS fresh, allowing a user to select, upon entry into a BIOS setup utility, an option of execution of BIOS fresh and therefore fresh the BIOS without the need of an operating system.

### SUMMARY OF THE INVENTION

It is the objective of the present invention to provide a computer motherboard with a Basic Input Output System (BIOS) capable of built-in BIOS fresh, allowing a user to select, upon entry into a BIOS setup utility, an option of execution of BIOS fresh and therefore fresh the BIOS without using an operating system.

To achieve the above and other objectives, the present invention provides a computer motherboard with a BIOS capable of built-in BIOS fresh, characterized in that the BIOS comprises: a first means being code integral to the BIOS and executable by a central processing unit (CPU) of the computer motherboard upon entry into an execution environment preset by the BIOS, thereby allowing a BIOS update file stored in a storage device to be selected, wherein the storage device is connected to the computer motherboard via an interface of the computer motherboard and configured to at least store the BIOS update file; and a second means being code integral to the BIOS and executable by the CPU of the computer motherboard upon entry into an execution environment preset by the BIOS so as for the BIOS update file to be freshed and stored in a BIOS memory.

### BRIEF DESCRIPTION OF THE DRAWINGS

To enable persons skilled in the art to gain insight into the structures, features, and effects of use of the present invention, the present invention is hereunder illustrated with preferred embodiments in conjunction with the accompanying drawings, wherein:

FIG. 1 is a schematic view of the framework of a computer motherboard of the present invention;

FIG. 2 is a flow chart of BIOS fresh executed by the computer motherboard of the present invention;

FIG. 3 is a screen shot of a BIOS setup utility configured for the computer motherboard of the present invention;

FIG. 4 is a screen shot of BIOS fresh carried out by the computer motherboard of the present invention;

FIG. 5 is a screen shot showing how to select a BIOS update file in a storage device by the BIOS of the computer motherboard of the present invention;

FIG. 6 is a screen shot showing how a user confirms that BIOS code in the BIOS is to be freshed by the computer motherboard of the present invention; and

FIG. 7A through FIG. 7C are screen shots showing how the user confirms that the BIOS code in the BIOS is to be saved by the computer motherboard of the present invention.

### DETAILED DESCRIPTION OF THE INVENTION

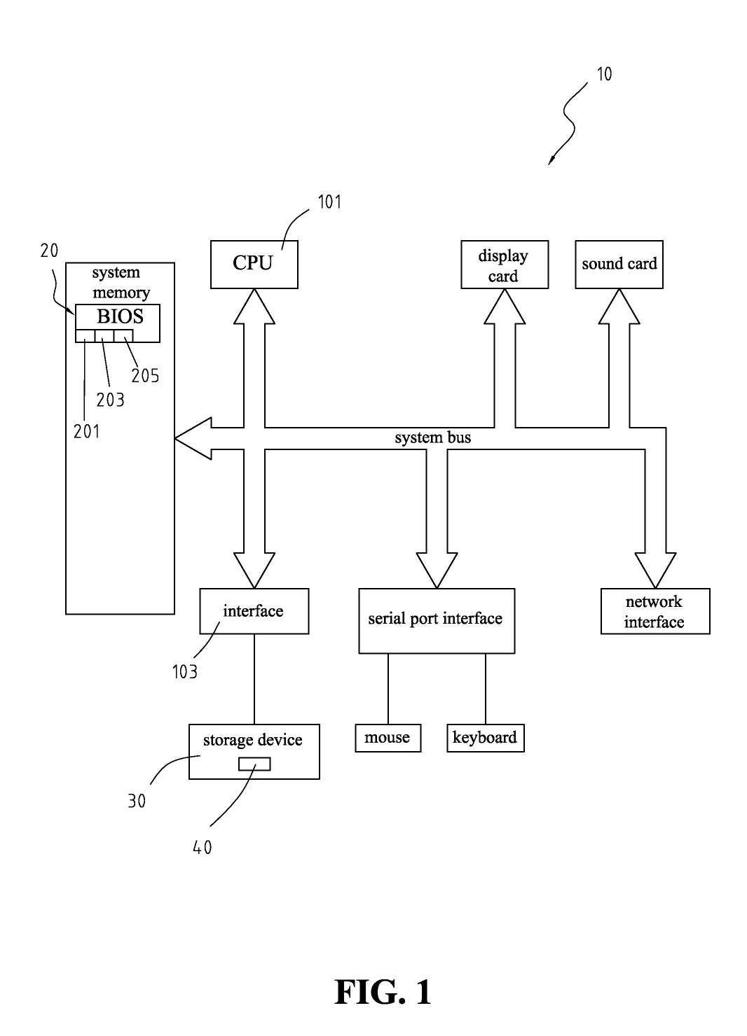

Referring to FIG. 1, which is a schematic view of the framework of a computer motherboard of the present invention, a computer motherboard 10 of the present invention is characterized in that: a Basic Input Output System (BIOS) 20 is capable of built-in BIOS fresh so as to allow a user to enter the BIOS screen after the computer is powered on (for example, by pressing the Del key on the keyboard) and fresh BIOS code by following operation instructions displayed on the BIOS screen. As shown in the drawing, the computer motherboard 10 of the present invention is further characterized in that: a BIOS update file is stored in a storage device (for example, a USB storage device or a memory card), and the user directly selects the BIOS update file stored in the storage device by following operation instructions displayed on the BIOS screen.

The computer motherboard 10 of the present invention comprises the BIOS 20. The BIOS 20 which is different from a conventional BIOS comprises a first means 201 and a second means 203. Related details are disclosed hereunder. The first means 201 is code integral to the BIOS 20. The first means 201 is executable by a central processing unit (CPU) 101 of the computer motherboard 10. In an execution environment of the BIOS 20, the CPU 101 executes the first means 201 and thereby enables the user to select a BIOS update file 40 stored in a storage device 30.

The second means 203 is code integral to the BIOS 20. The second means 203 is executable by the CPU 101. In an execution environment of the BIOS 20, the CPU 101 executes the second means 203 such that the BIOS update file 40 is freshed and stored in a BIOS memory for storing the new code of the BIOS 20.

The storage device 30 is connected to the computer motherboard 10 via an interface 103 of the computer motherboard 10. The storage device 30 is configured to at least store the BIOS update file 40. The storage device 30 is, for example, a USB storage device or a memory card. Specifically speaking, the storage device 30 is, for example, a USB flash drive, an SD memory card, or a microSD memory card.

The interface 103 is, for example, a USB interface, a memory card interface, or a card reader interface.

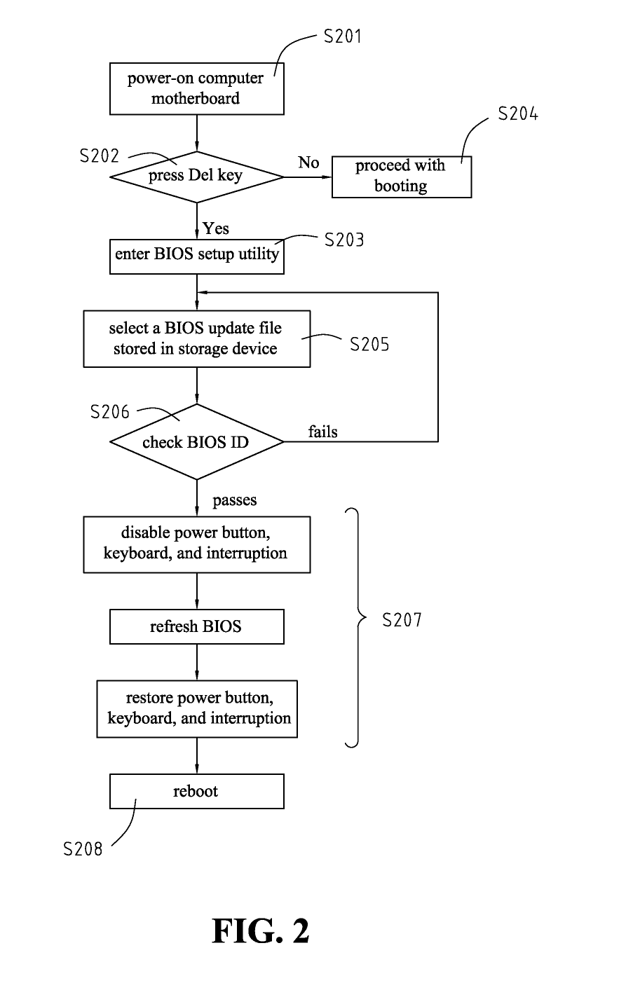

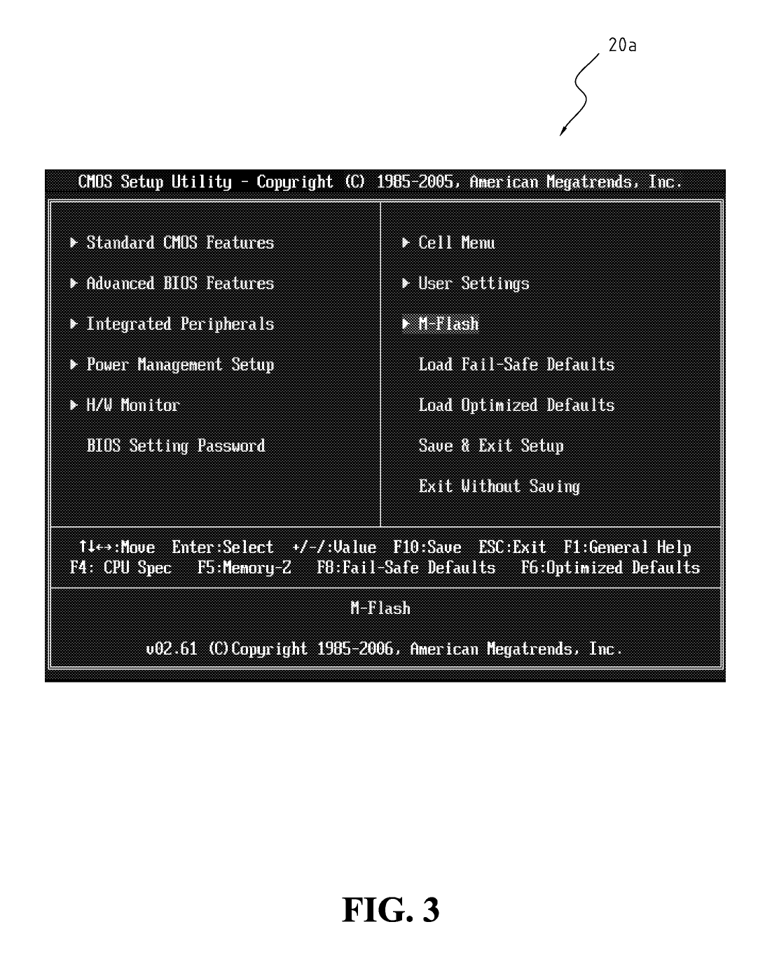

Referring to FIG. 2, which is a flow chart of BIOS fresh executed by the computer motherboard 10 of the present invention, after the computer motherboard 10 is powered on (S201), the BIOS 20 checks the keyboard to determine whether the Del key has been pressed (S202), and a TRUE determination is followed by entry into a BIOS setup utility (S203), or else booting continues (S204). FIG. 3 shows a screen shot 20a of the BIOS setup utility (mentioned earlier in step 203) wherein the mark M-Flash indicates an option of execution of BIOS fresh of the present invention. The mark M-Flash used herein serves an illustrative purpose but is not used to limit the present invention.

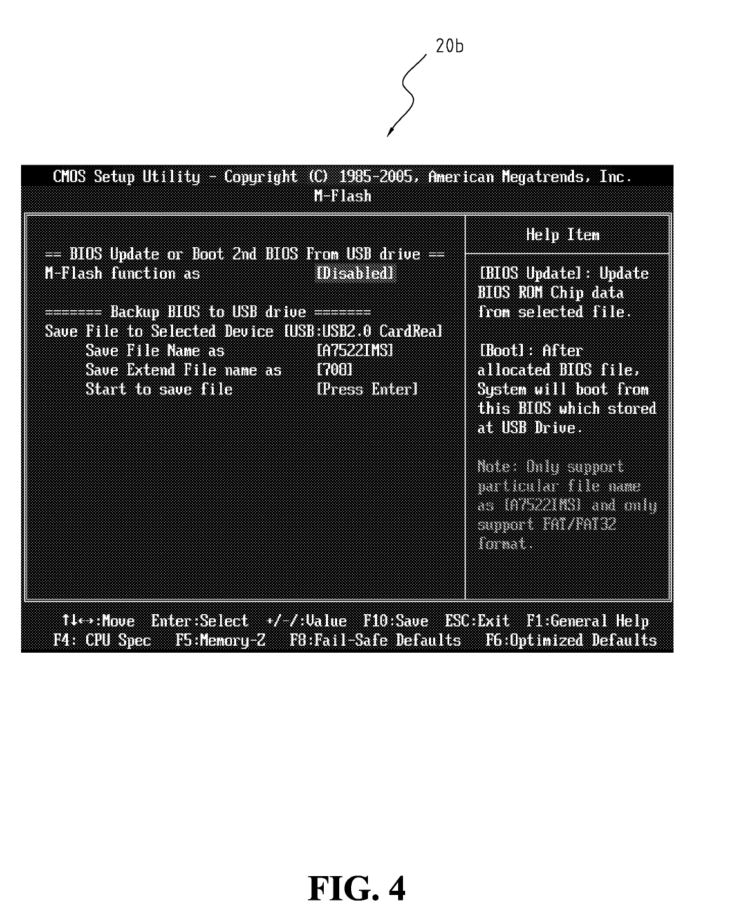

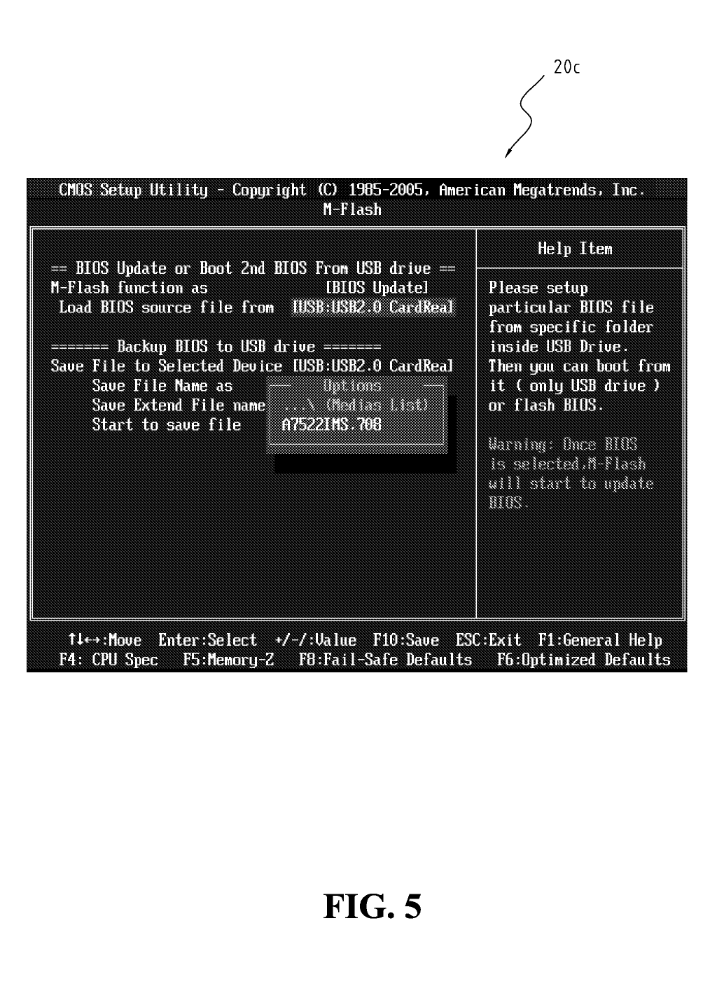

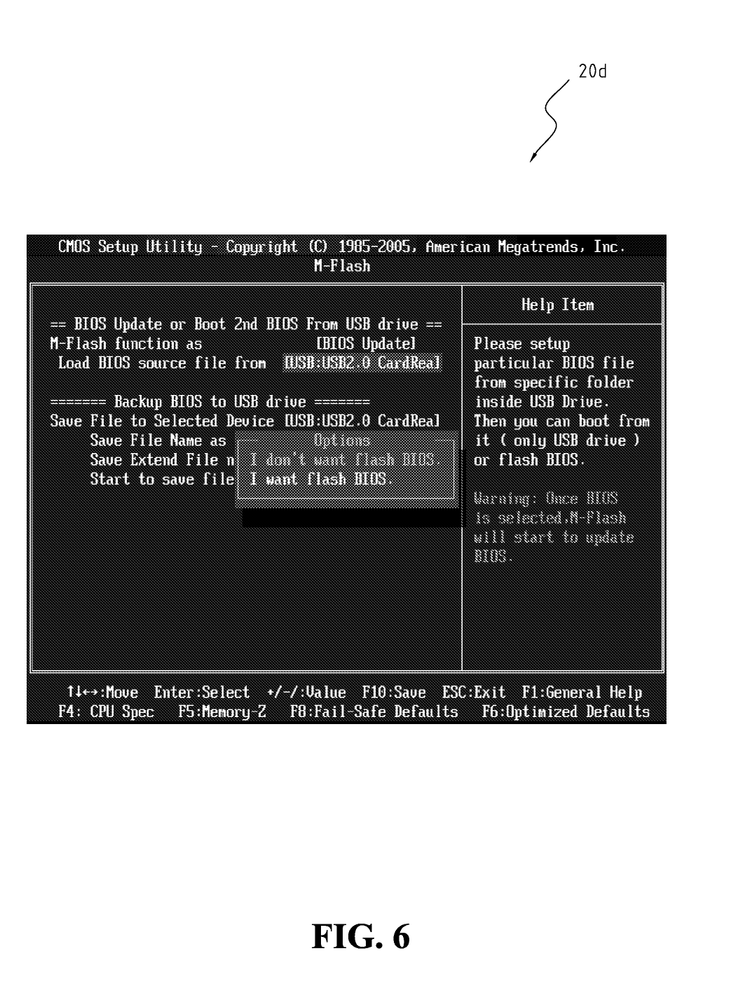

A screen shot 20b of BIOS fresh shown in FIG. 4 appears as soon as the user selects execution of BIOS fresh of the present invention. Afterward, the user selects the BIOS update file 40 stored in the storage device 30 (S205). Referring to FIG. 5, which is a screen shot 20c showing how to select the BIOS update file 40 in the storage device 30 by the BIOS 20 of the computer motherboard 10 of the present invention, the user selects the BIOS update file 40 identified by a filename “A7522IMS.708” and saved in a memory card inserted in a card reader. Then, the BIOS 20 checks the BIOS update file 40 for the ID of the BIOS code (S206), a follow-up step of BIOS fresh is executed when the check passes (S207). Referring to FIG. 6, which is a screen shot 20d showing how the user confirms that the BIOS code in the BIOS 20 is to be freshed, the new BIOS code is flashed in a BIOS memory of the BIOS 20. If the check fails, the user will have to select the BIOS update file 40 again. Eventually, after the BIOS code has been freshed, the computer motherboard reboots (S208).

In step S207, prior to BIOS fresh, disabling a power button, a keyboard, and interruption precludes any adverse outcome of the user's improper operation and therefore ensures that BIOS fresh can be smoothly carried out. Upon completion of BIOS fresh, the power button, the keyboard, and interruption are resumed.

The BIOS 20 further comprises a third means 205. The third means 205 is code integral to the BIOS 20. The third means 205 is executable by the CPU 101 of the computer motherboard 10. In an execution environment of the BIOS 20, the CPU 101 executes the third means 205 and thereby backs up the BIOS code of the computer motherboard 10 and stored the backup BIOS code in the storage device 30.

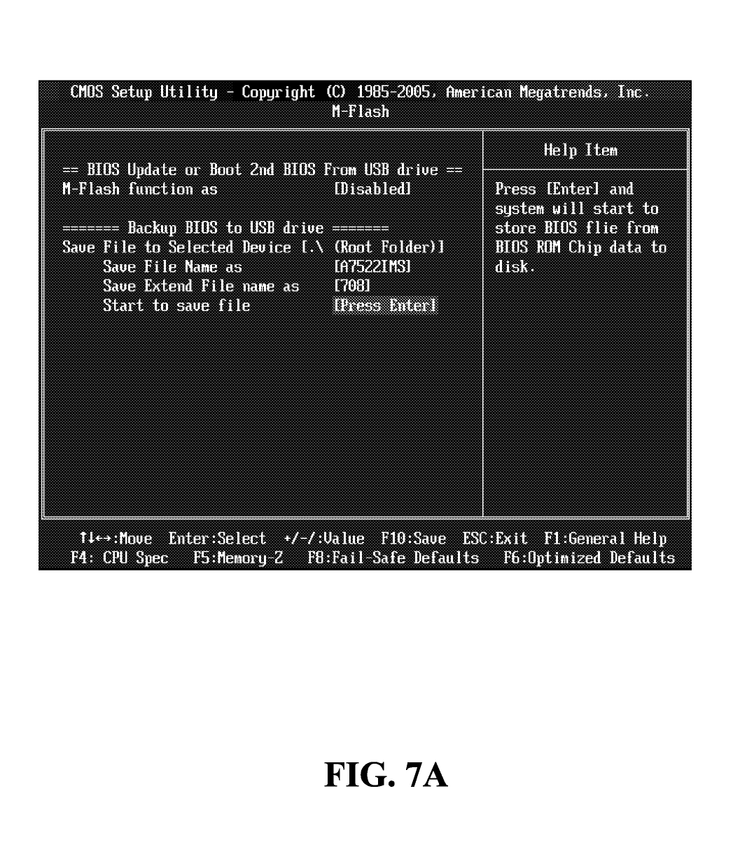

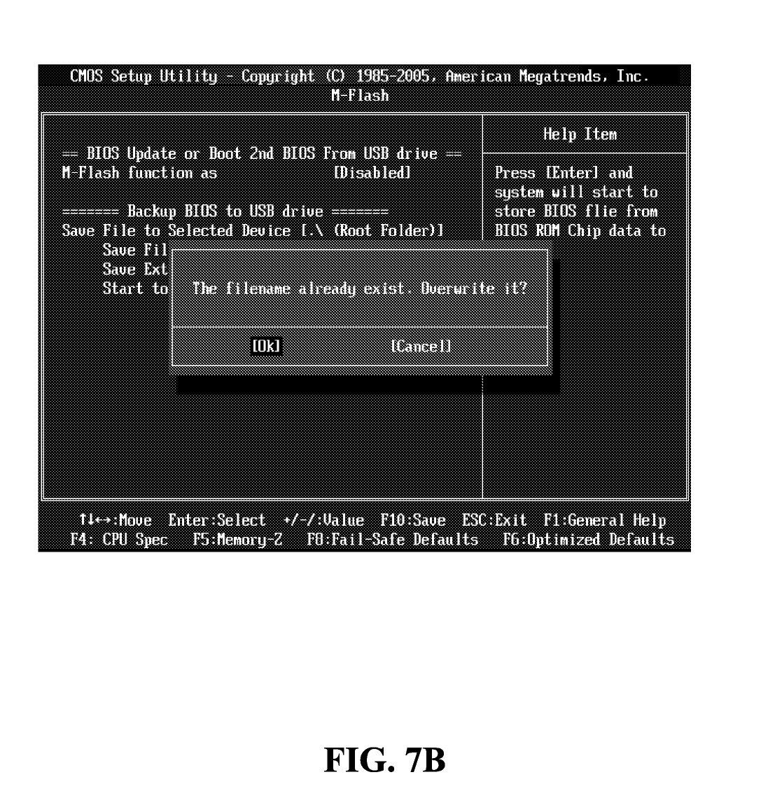

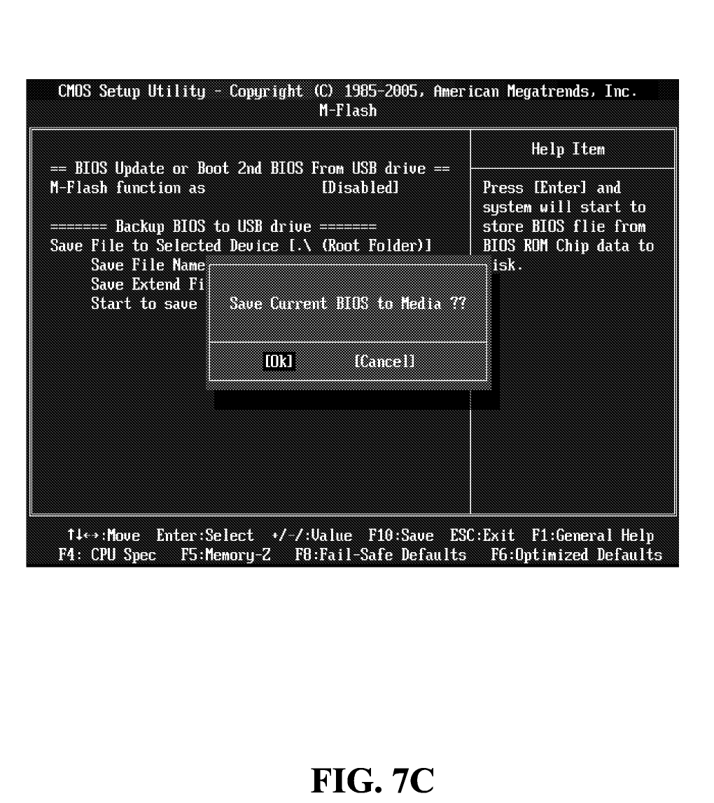

FIG. 7A through FIG. 7C are screen shots showing that, in an execution environment of the BIOS 20, the CPU 101 executes the third means 205 and thereby stores the BIOS code of the computer motherboard 10 in the storage device 30.

The computer motherboard of the present invention enables users to be less dependent on an operating system when updating BIOS, minimizes the chance of users' erring, and therefore reducing the chance of users' returning the computer motherboard to the manufacturer of for maintenance. With a BIOS setup interface and support from the storage device, the computer motherboard of the present invention is capable of integrated BIOS fresh such that, upon entry into a BIOS setup utility, a user can select the storage device and then select a BIOS update file from a menu. The computer motherboard of the present invention automatically confirms that the computer motherboard matches the BIOS before BIOS fresh starts. The above technical features embody the advantages of the present invention.

The above description serves to expound preferred embodiments of the present invention rather than limit the scope of application of the present invention. Persons skilled in the art should be able to make obvious changes or modification of the present invention without departing from the substantive disclosure of the present invention.

What is claimed is:

1. A computer motherboard with a Basic Input Output System (BIOS) capable of built-in BIOS fresh, characterized in that the BIOS comprises:
a first means being code integral to the BIOS and executable by a central processing unit (CPU) of the computer motherboard upon entry into an execution environment preset by the BIOS, thereby allowing a BIOS update file stored in a storage device to be selected, wherein the storage device is connected to the computer motherboard via an interface of the computer motherboard and configured to at least store the BIOS update file; and
a second means being code integral to the BIOS and executable by the CPU of the computer motherboard upon entry into an execution environment preset by the BIOS so as for the BIOS update file to be freshed in a BIOS memory.

2. The computer motherboard of claim 1, wherein the storage device is one of USB storage devices and memory card.

3. The computer motherboard of claim 2, wherein the USB storage device is a USB flash drive.

4. The computer motherboard of claim 1, wherein the BIOS further comprises:
a third means being code integral to the BIOS and executable by the CPU of the computer motherboard upon entry into the execution environment preset by the BIOS so as for code of the BIOS of the computer motherboard to be backed up and stored in the storage device.

5. The computer motherboard of claim 1, wherein the interface of the computer motherboard is one selected from the group consisting of a USB interface, a memory card interface, and a card reader interface.
